(19) United States
(12) Patent Application Publication
(10) Pub. No.: US 2008/0027928 A1
(43) Pub. Date: Jan. 31, 2008

(54) QuickView - combination of system and software components which enables search engine users to quickly identifiying relevant search returned results using visual images as references

(76) Inventor: Michael Douglas Larson, Maplewood, MN (US)

Correspondence Address: Michael D. Larson, 2315 Carver Avenue, Maplewood, MN, 55119, US

(21) Appl. No.: 11/827,287

(22) Filed: Jul. 11, 2007

Related U.S. Application Data
(60) Provisional application No. 60/831,563, filed on Jul. 19, 2006.

(51) Int. Cl. G06F 7/10; G06F 17/30; G06F 3/048; G06F 3/14

(52) U.S. Cl. 707/5; 707/1; 707/102; 707/3; 715/273; 715/764; 707/E17.005; 707/E17.017; 707/E17.019

(57) ABSTRACT

A method, apparatus, software components to identify images (WebPages Thumbnails, web documents, etc.) relevant to search engine query results, for displaying on computerized devices. The disclosed invention combines systems for database file searching, indexing, analysis, re-indexing, retrieval, and distribution and reviewing. Although, the primary purpose of this invention is to be integrated with Internet Search Engines to assist users (searchers) in sorting through return from their search query, which often are unrelated and redundant information, the invention can be used with other database systems as well. Unlike traditional search engine systems, the invention described herein incorporates a search engine Query Results capture and Analysis component with an Imaging System, which matches query results to related images of WebPages. Then utilizing a Query component coupled with Image retrieval and delivery components, both the searches engine query results and related WebPages Images added to the query results page viewing.

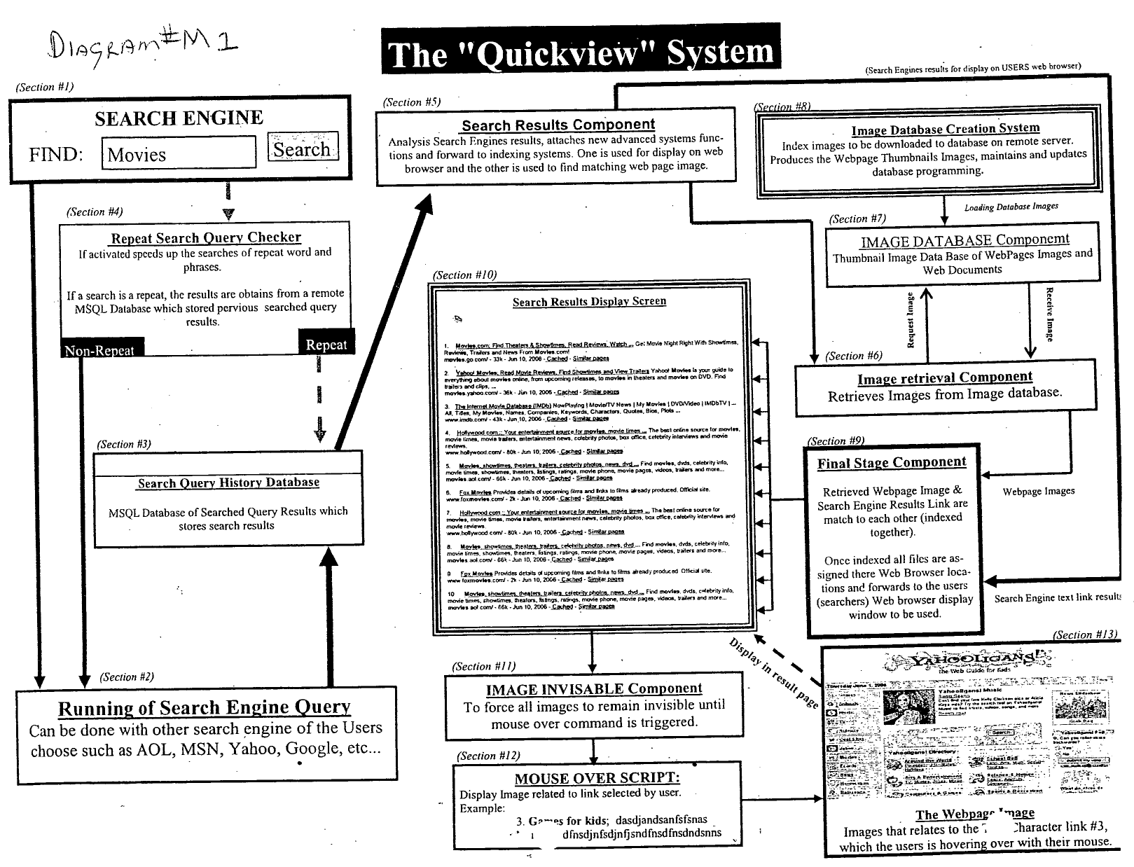

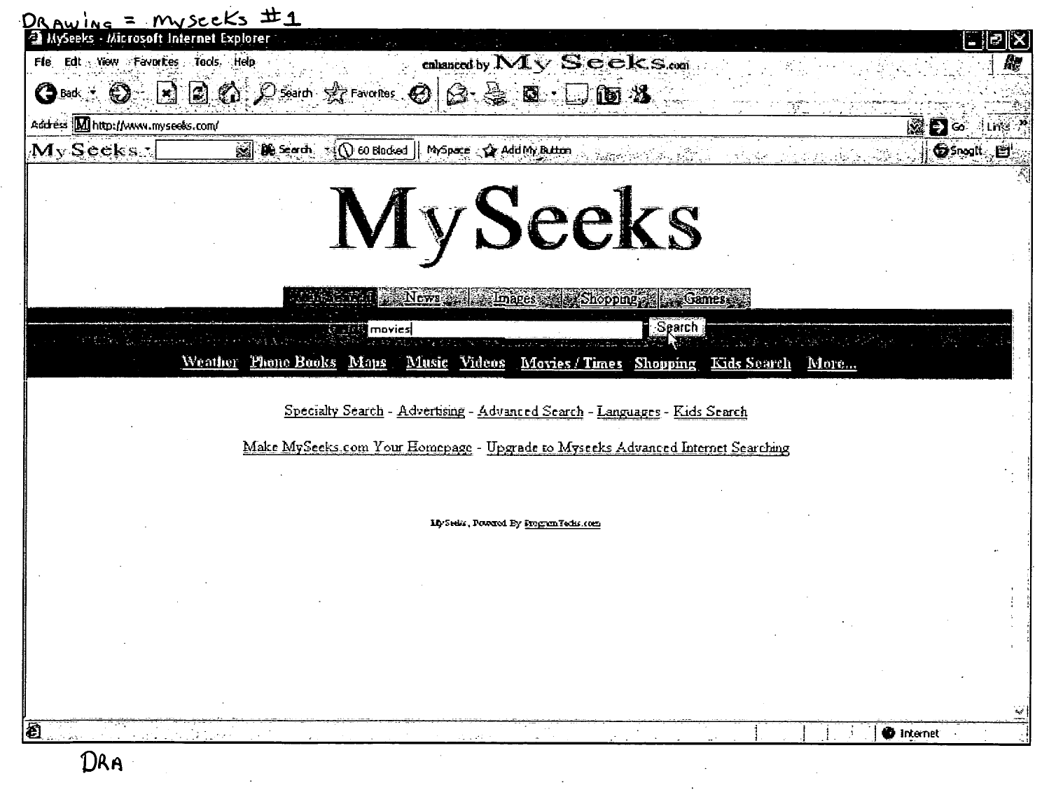

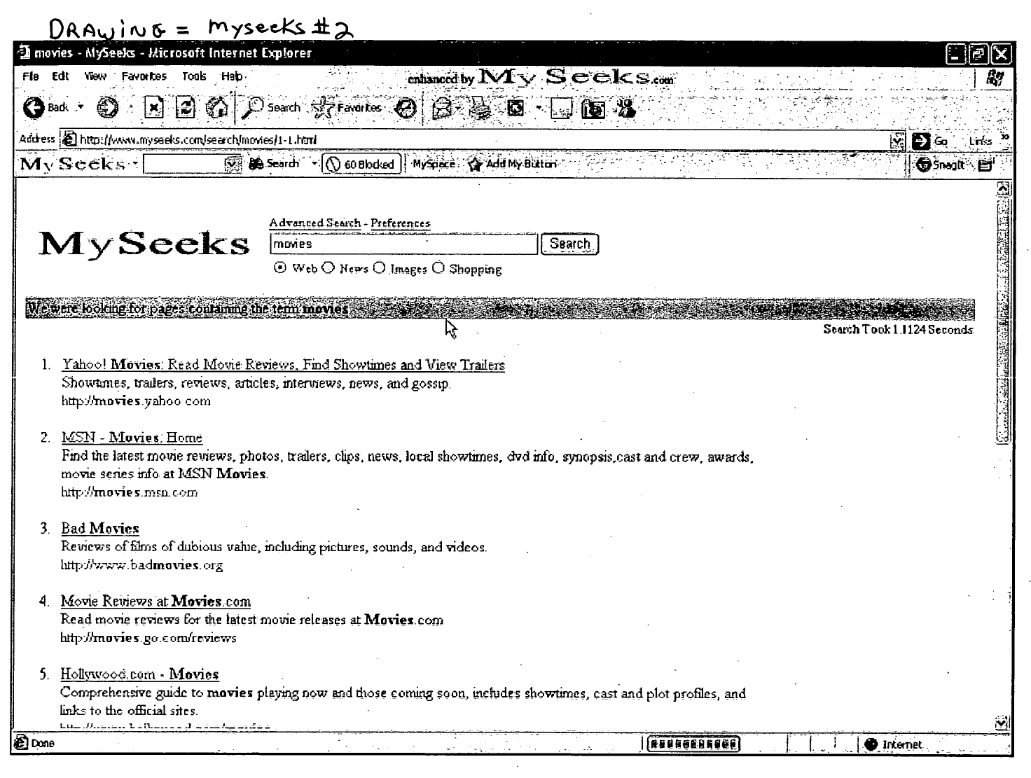

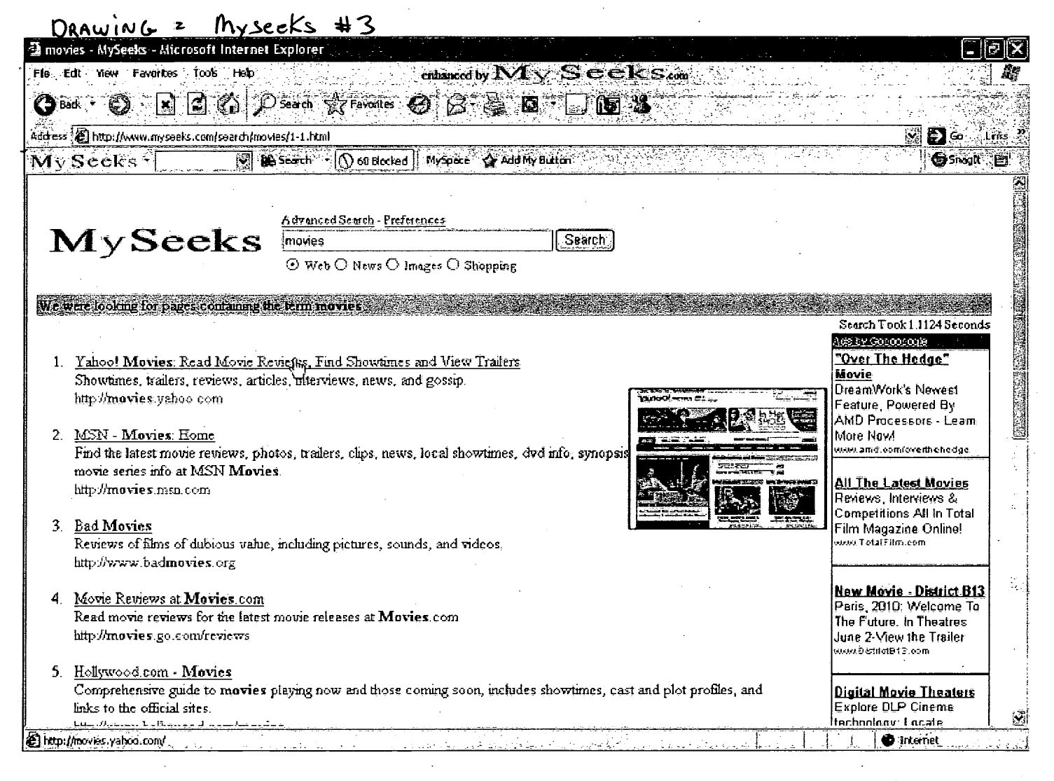

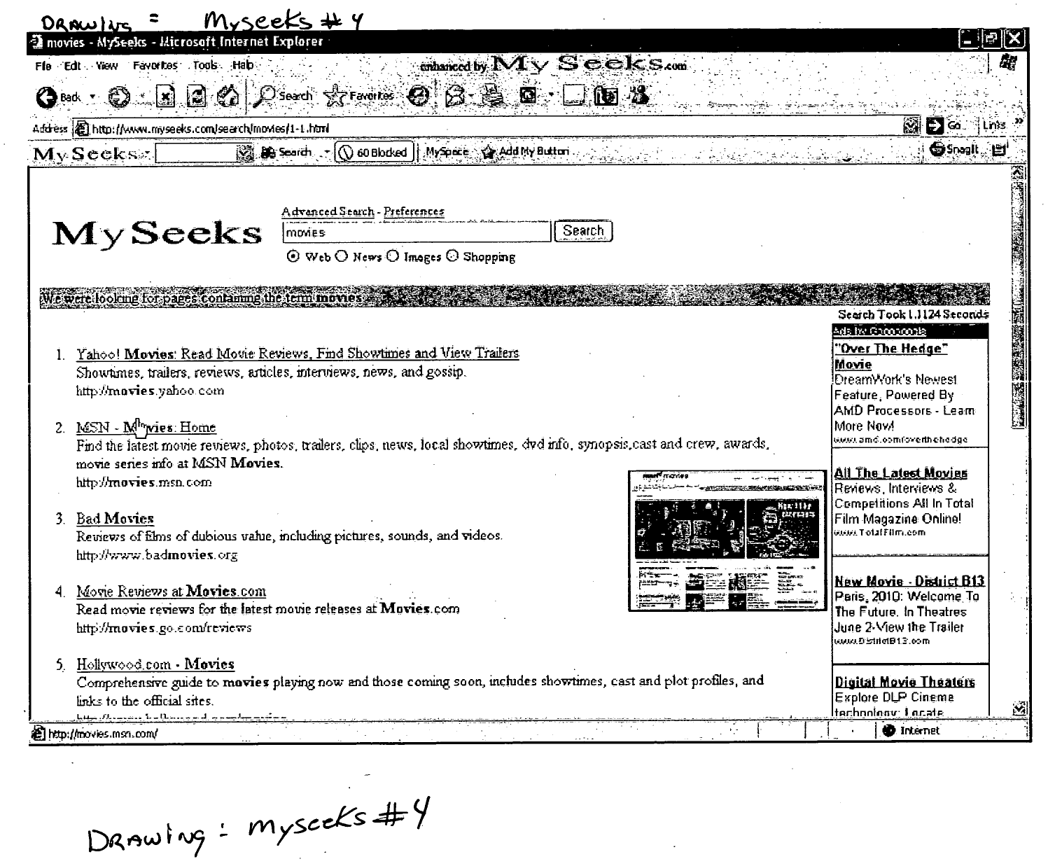

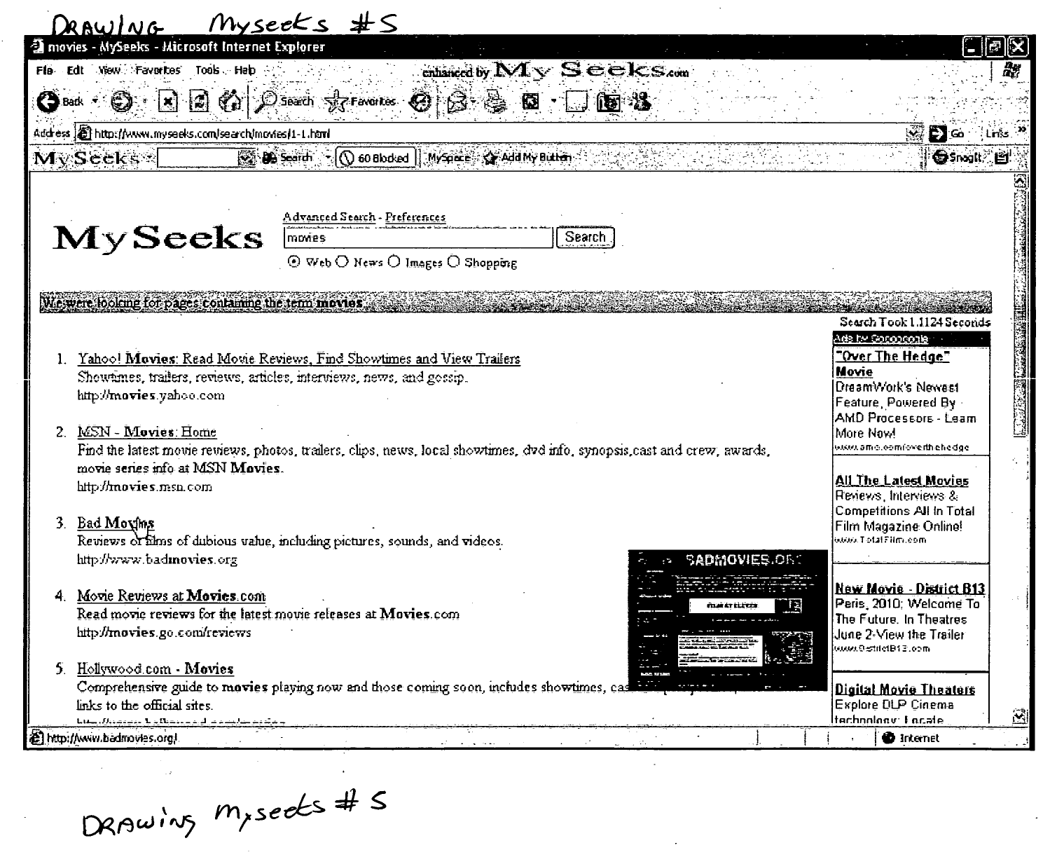

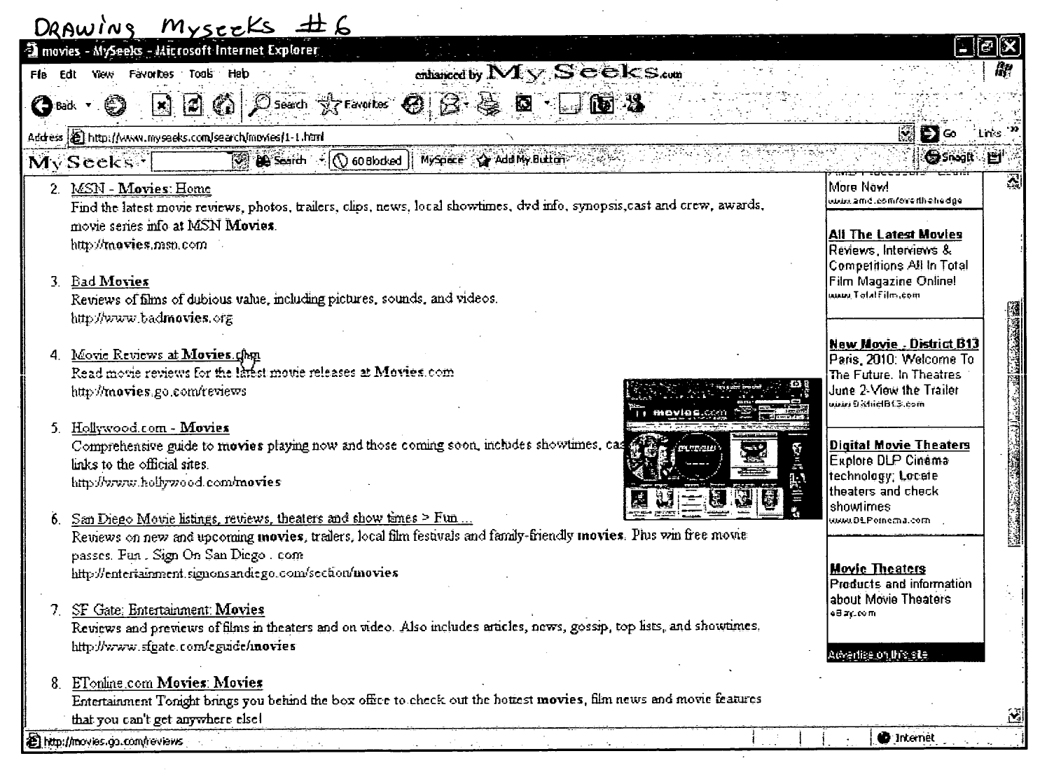

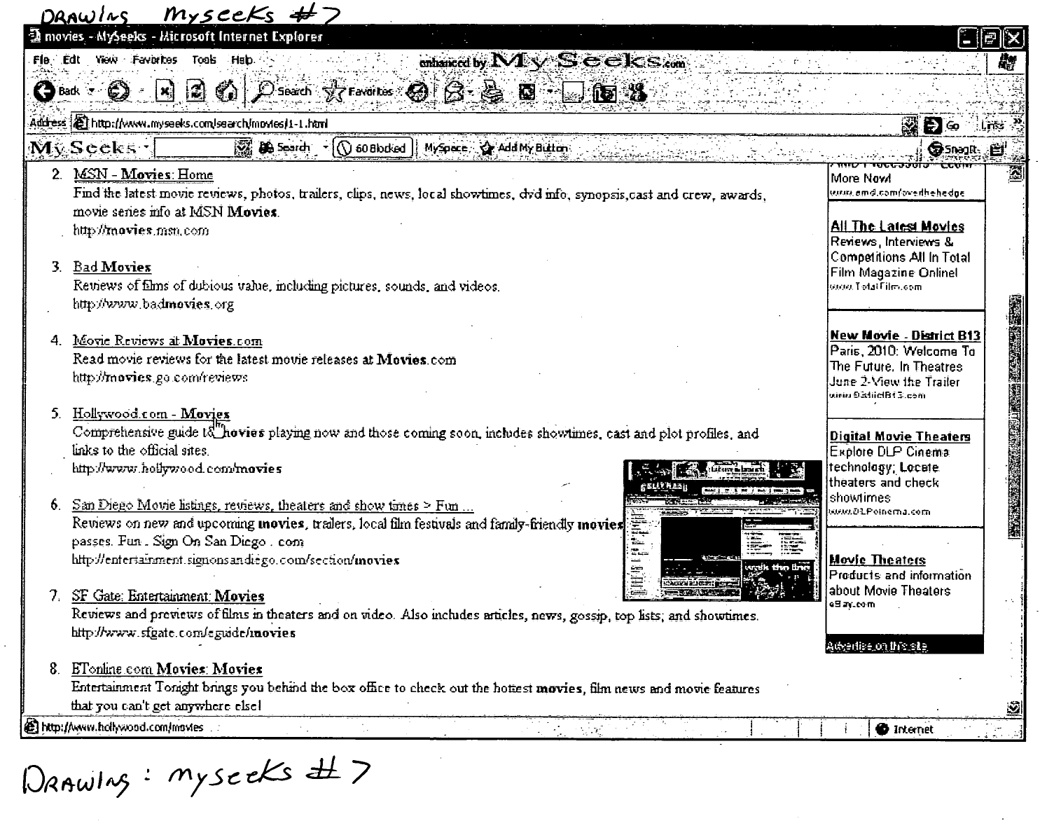

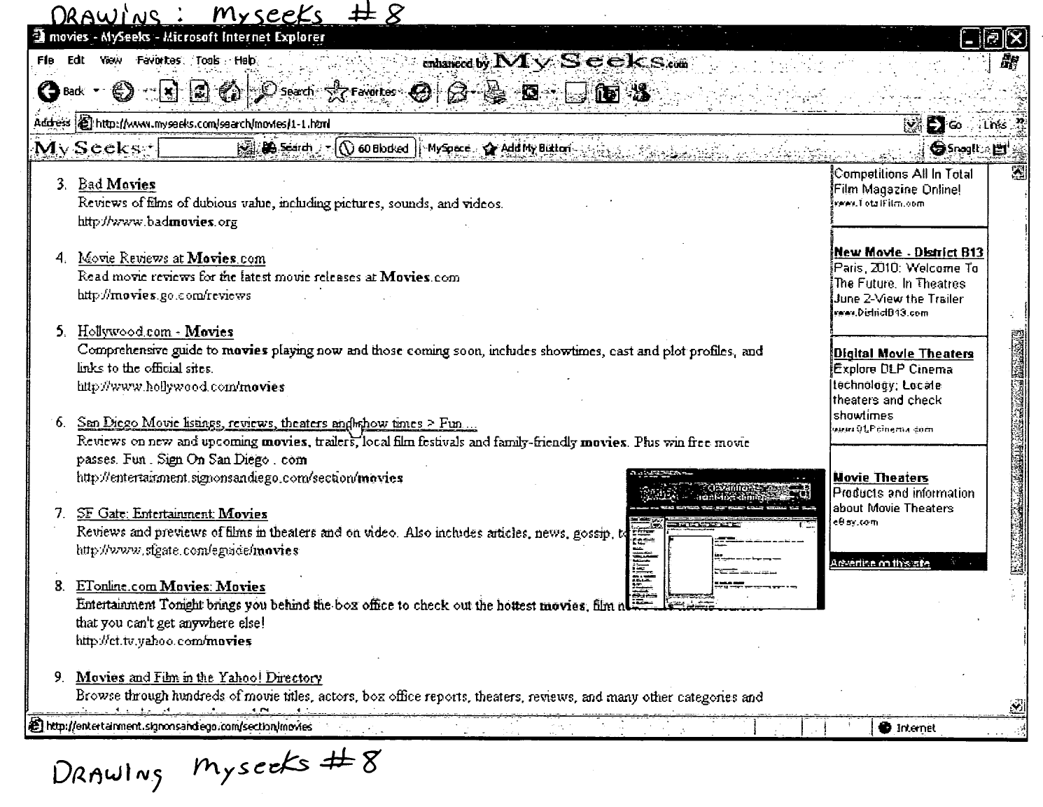

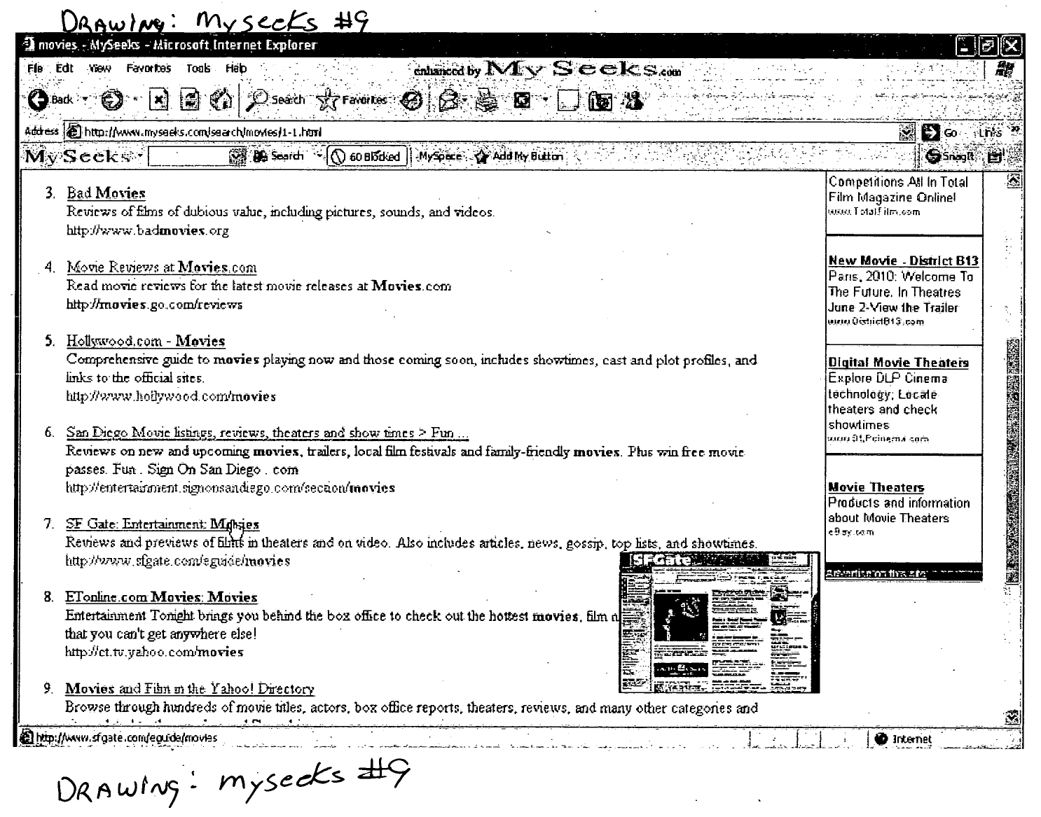

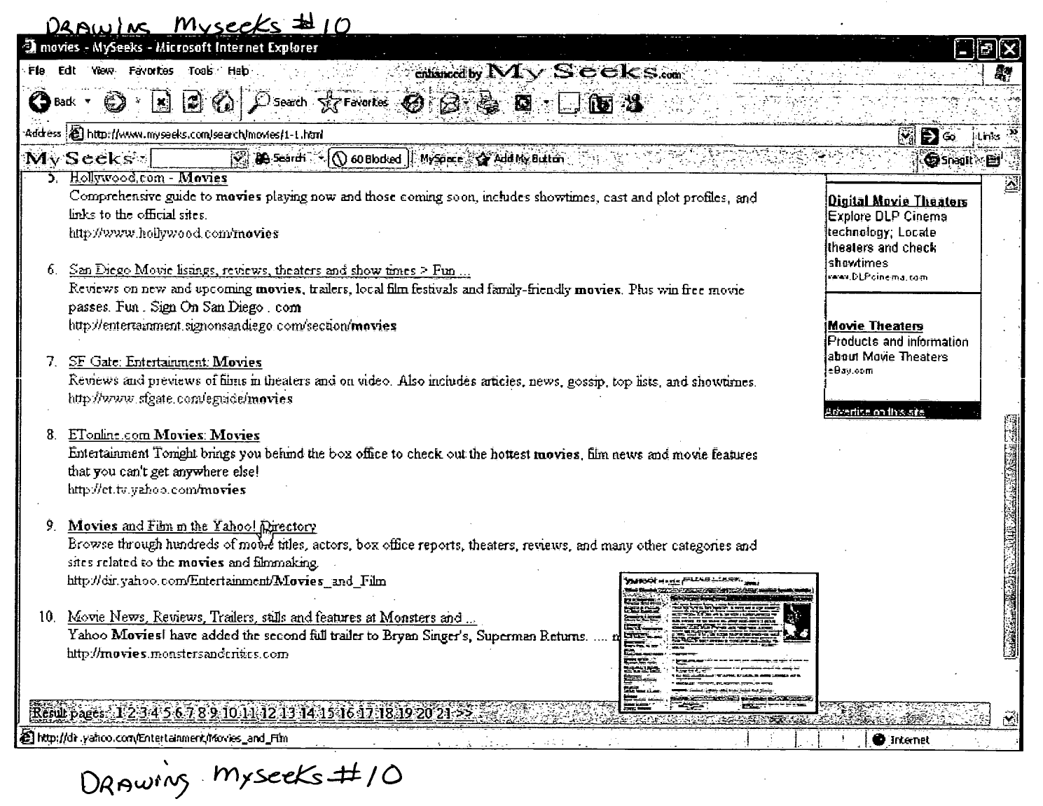

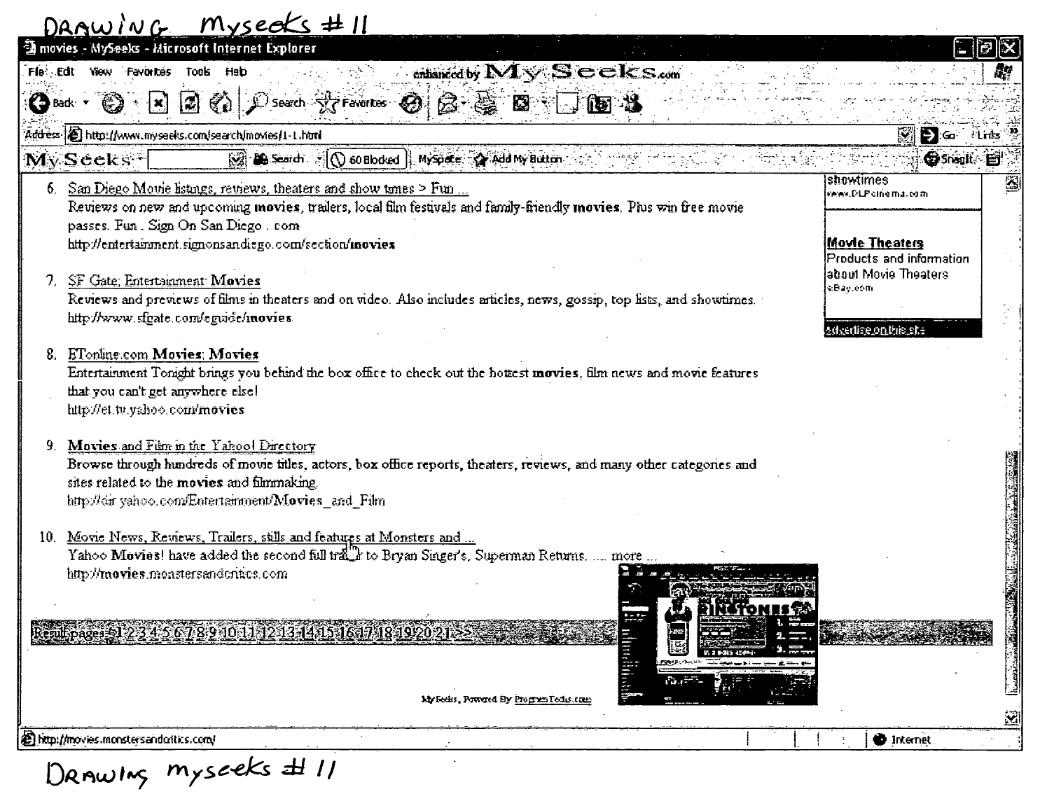

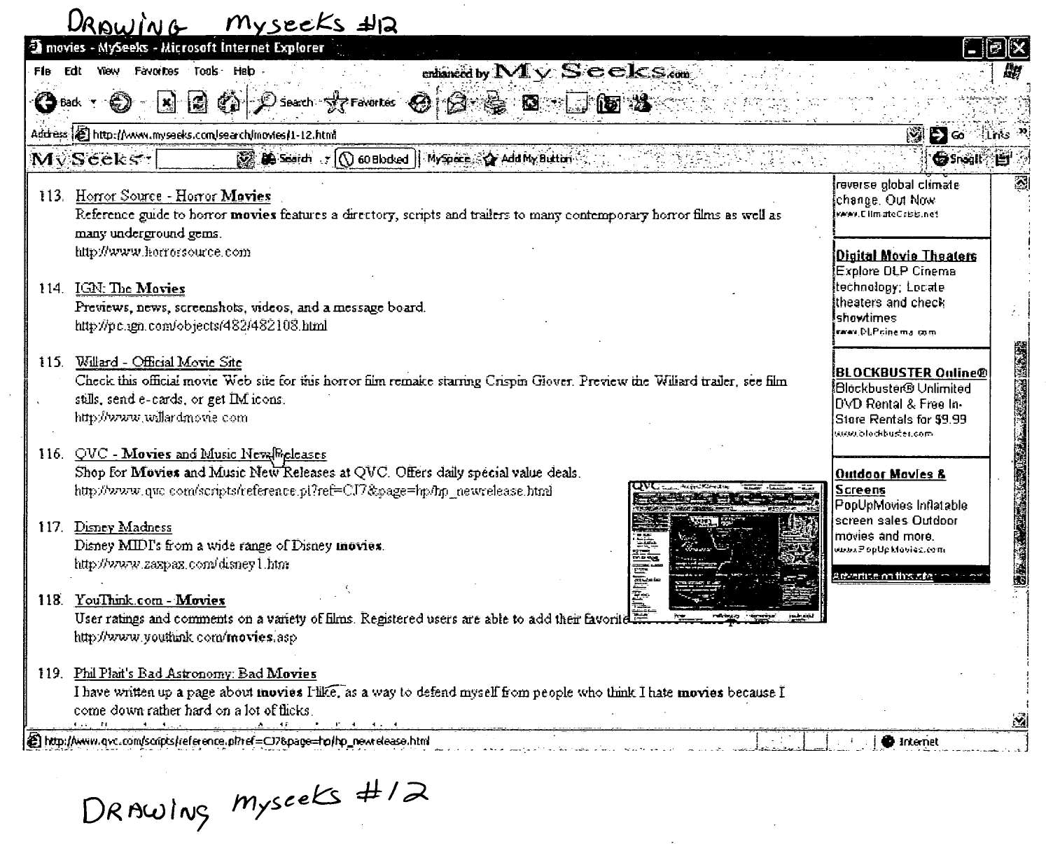

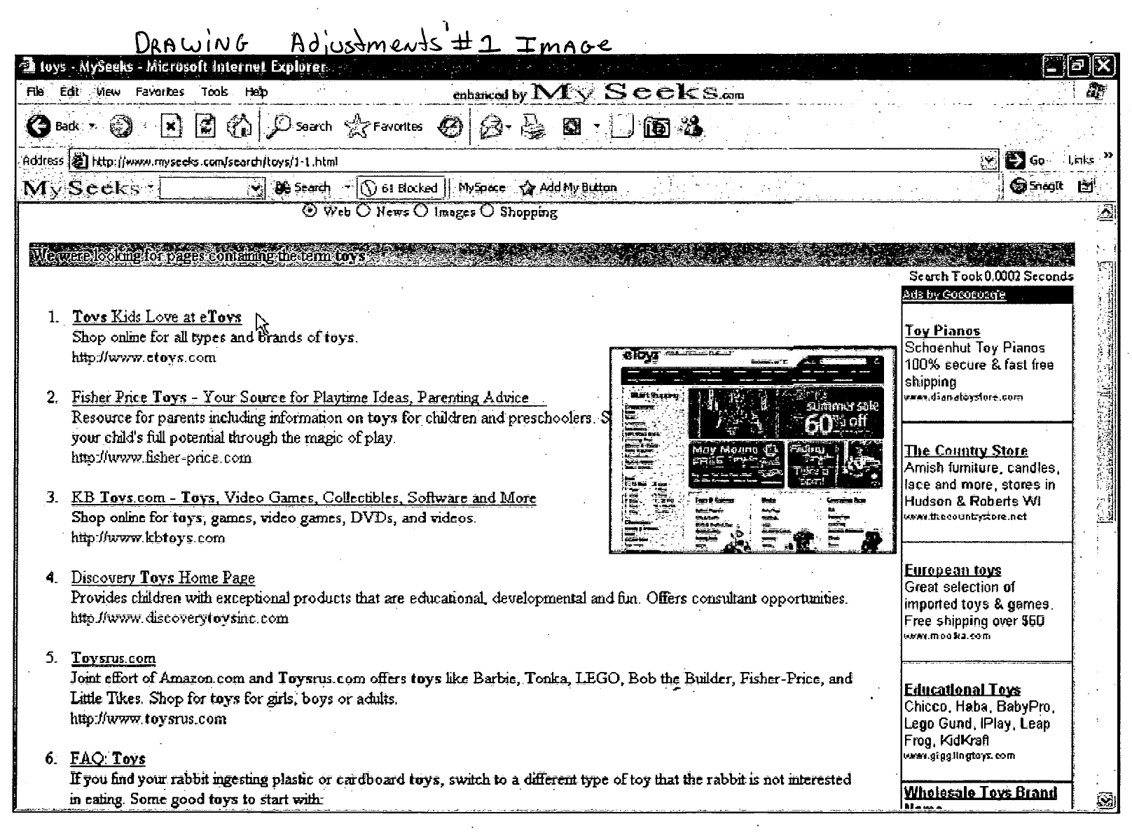

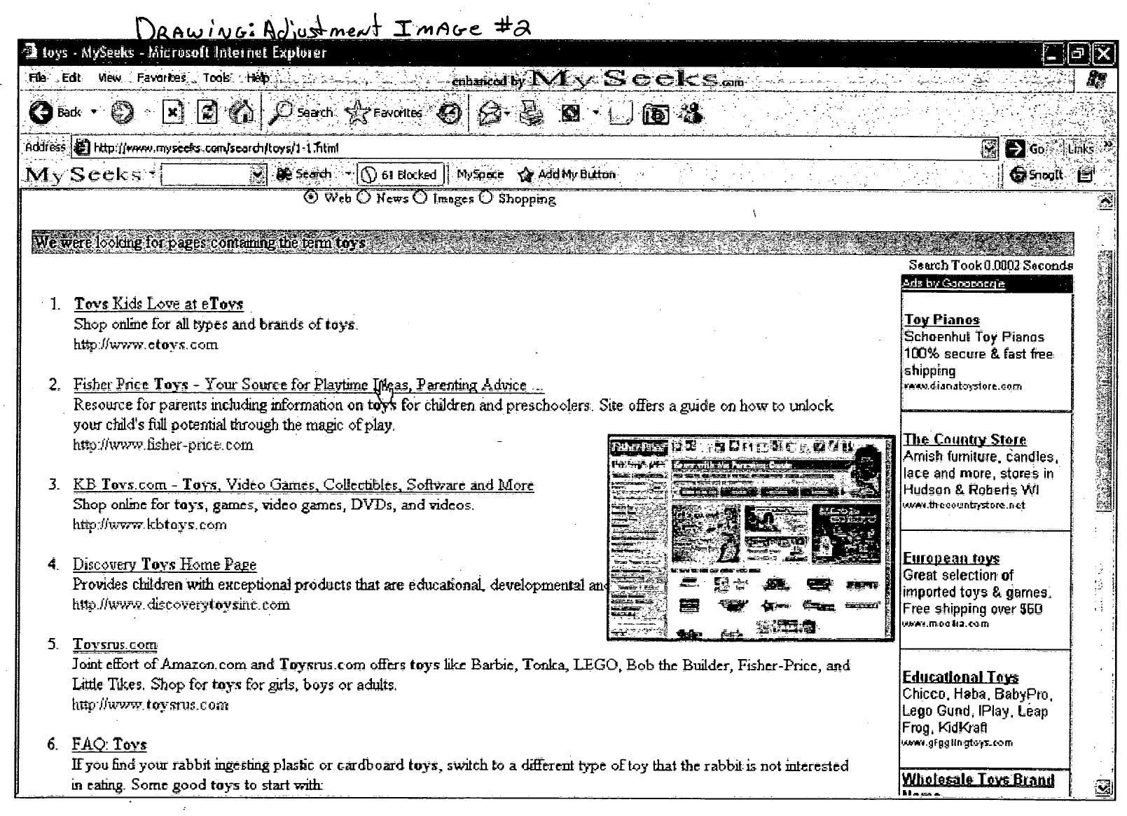

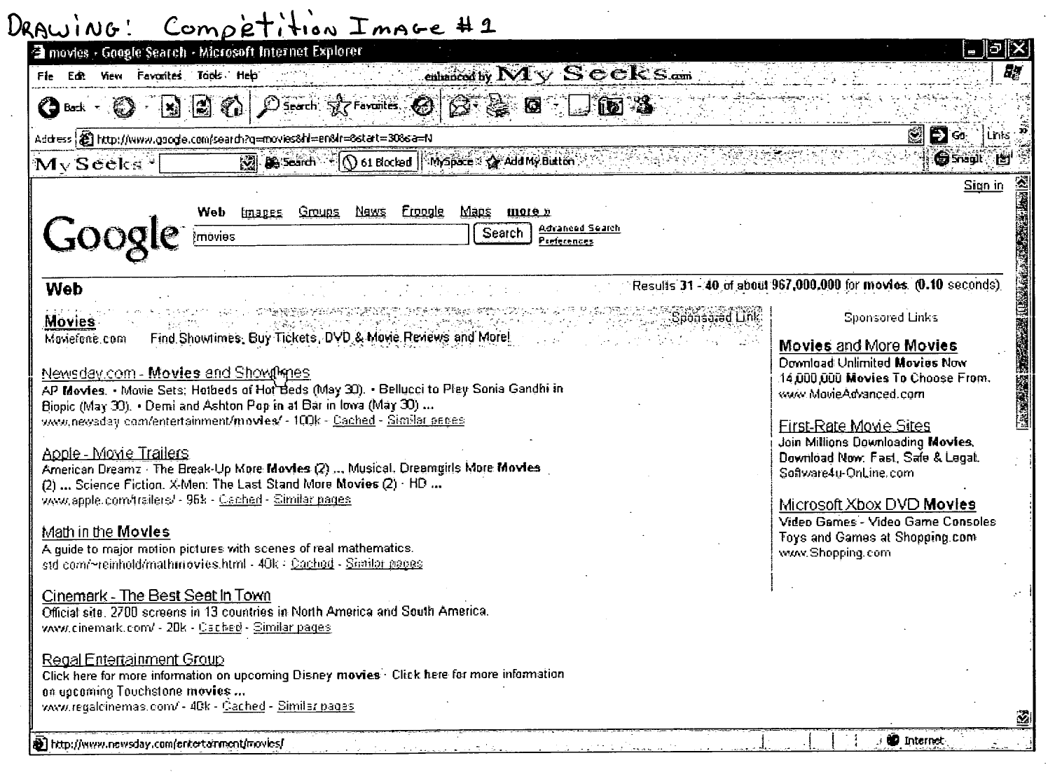

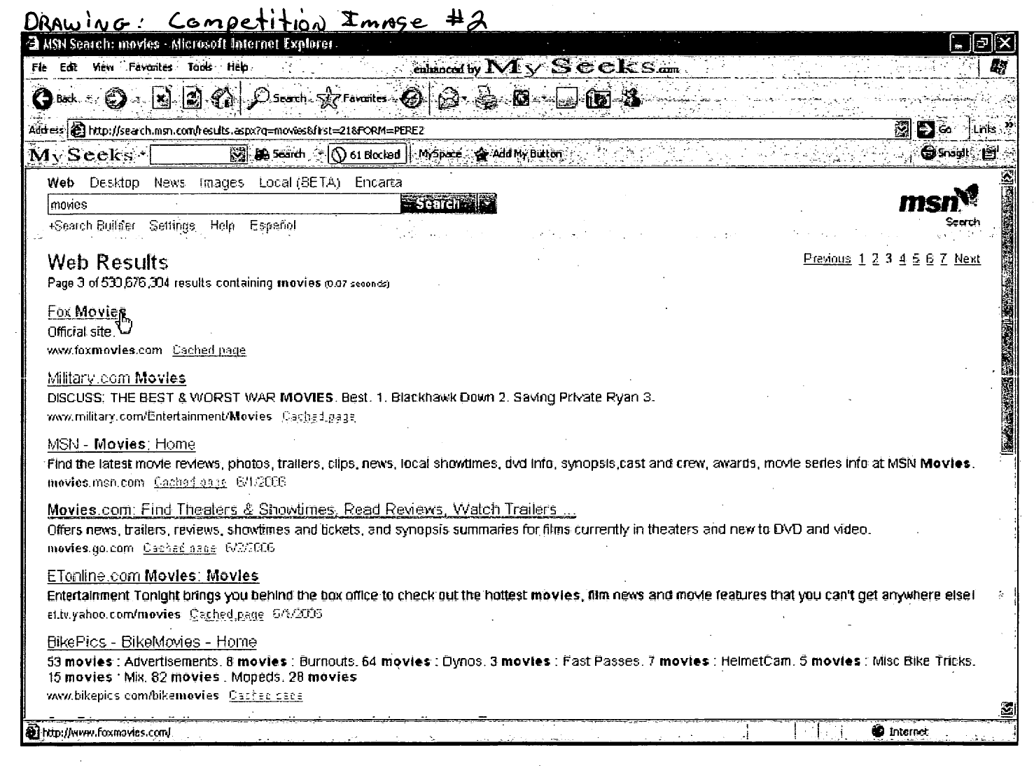

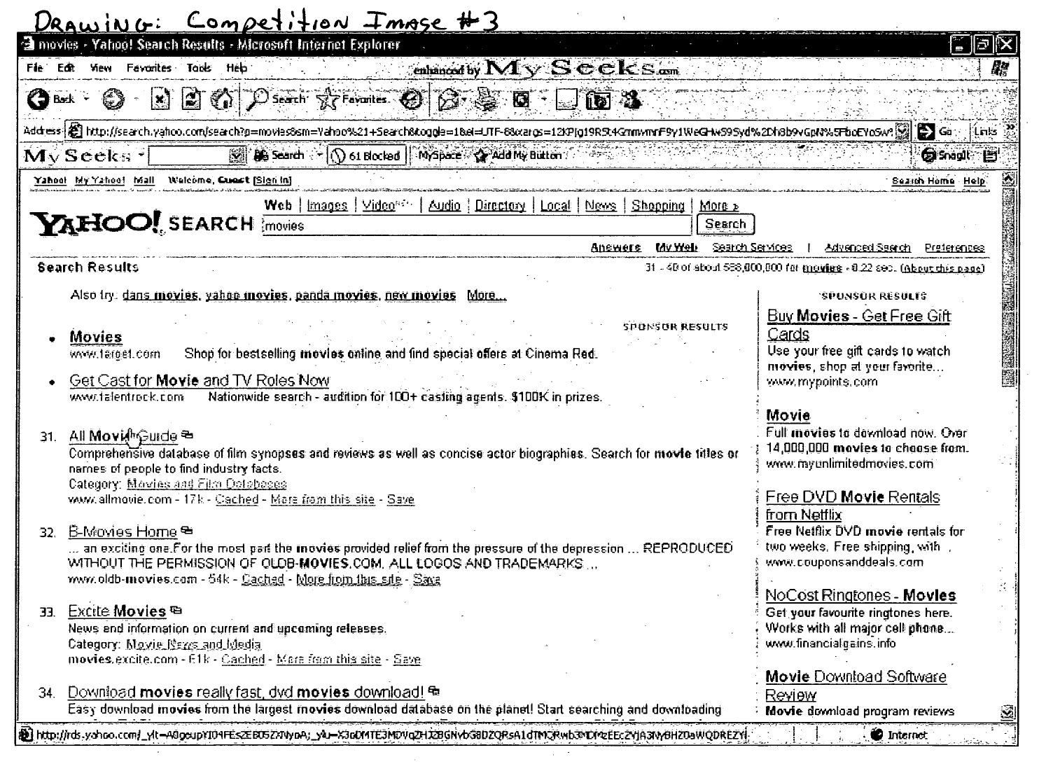

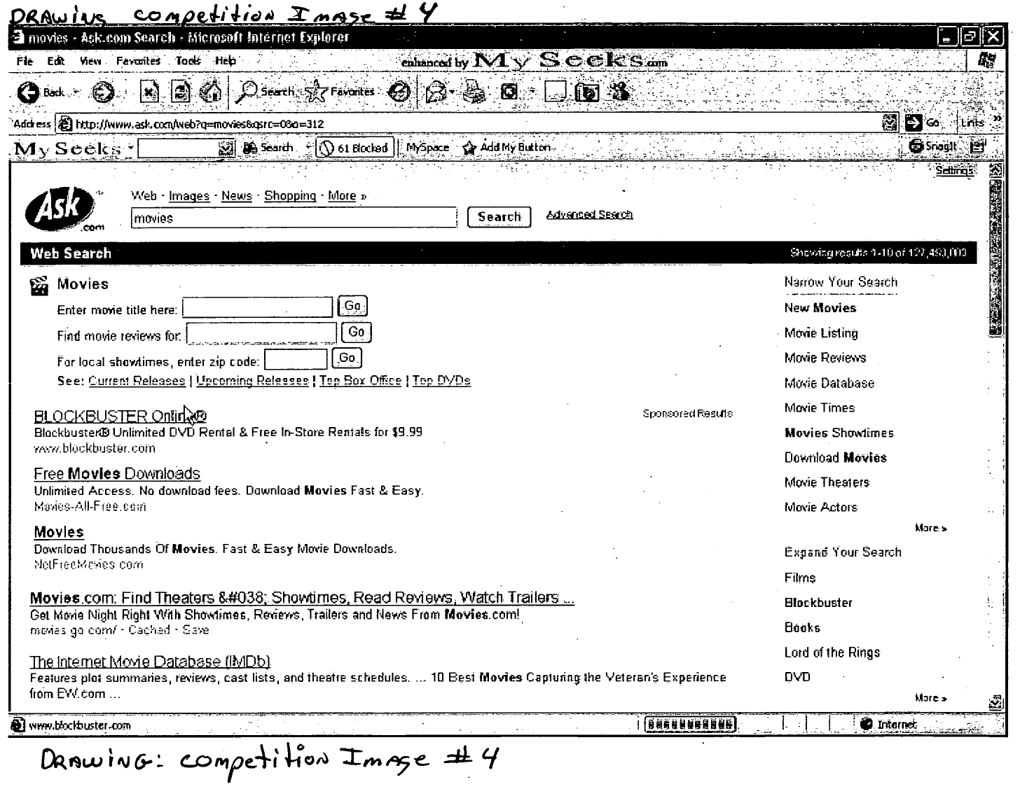

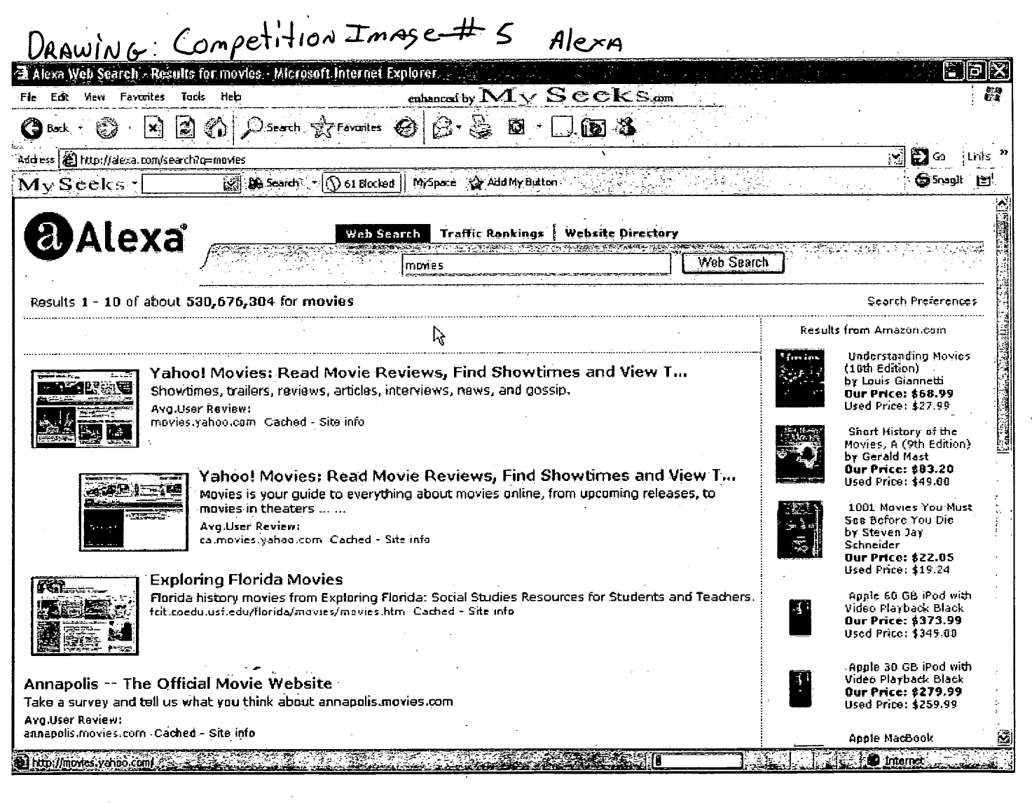

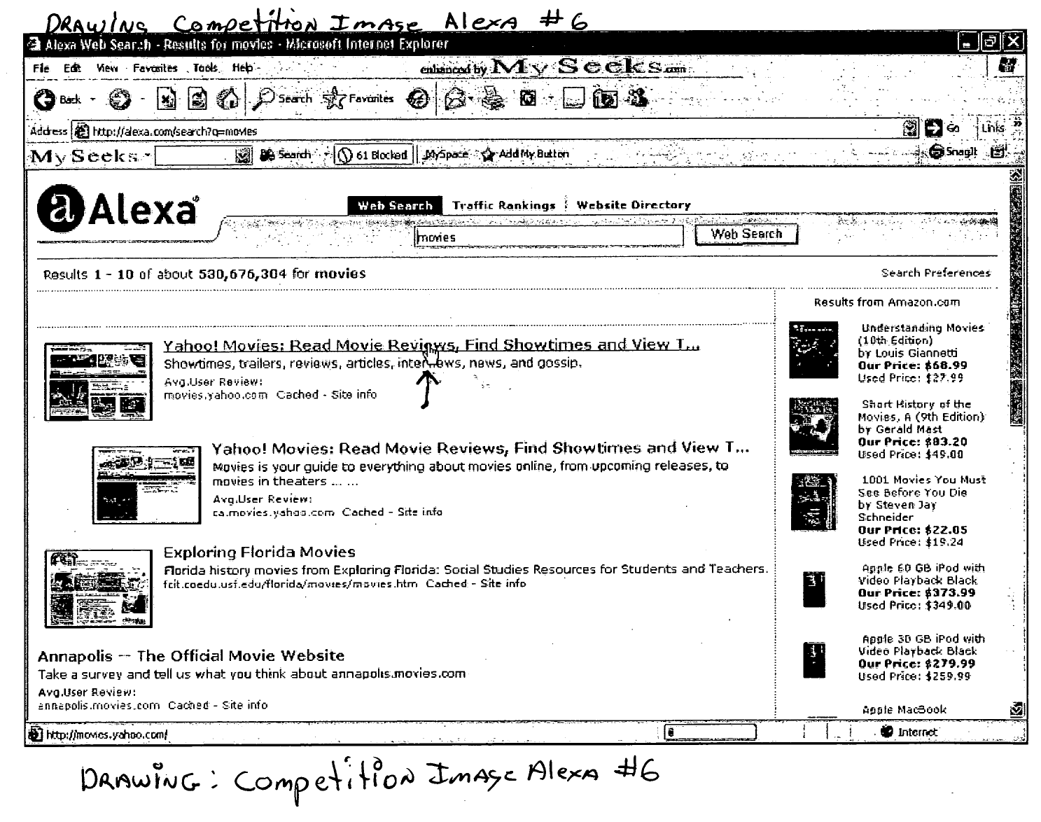

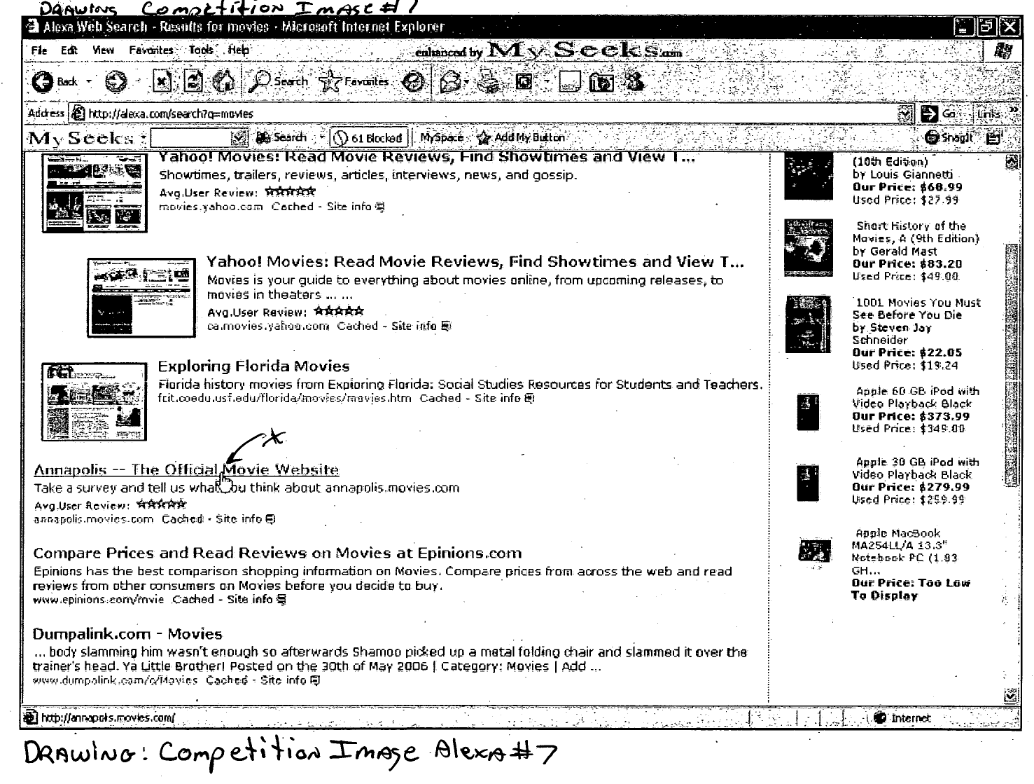

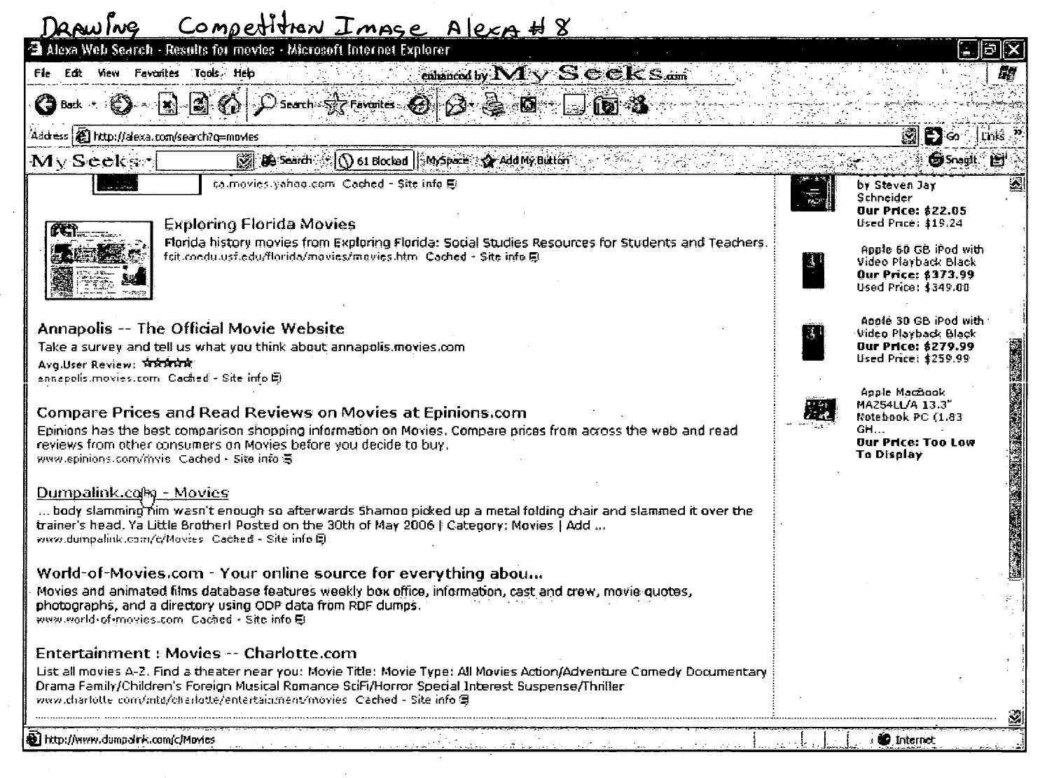

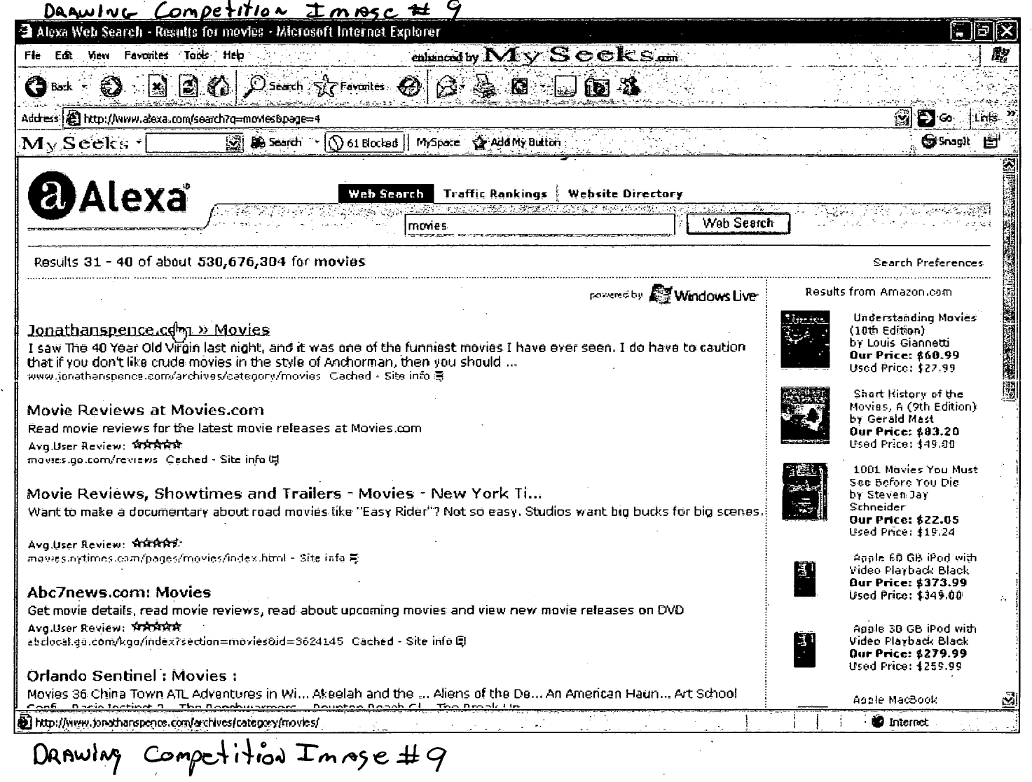

This Patent application is a continuing application of the earlier filing of the provisional application No. 60/831,563 which was filed on Jul. 19, 2006. In accordance with 35 U.S.C. 119 (e), this is a petition to convert provisional application No. 60/831,563 to a non-provisional patent within the established time period of 37 CFR 1.78.

### FIELD OF INVENTION

The field of the invention relates to the databases search engines. With a strong emphasis on database searching software applications designed to retrieve and preview information over the Internet (World Wide Web).

It is to be understood that this invention is not limited in its application to the embodiments described above, and the invention is capable of being practiced or carried out in various ways. For example, the retrieval method and software system of the present invention is not limited in their application to search WebPages and Web documents on the Internet. The invention is also applicable to search document files of other computer databases, medical equipment, wireless devices, etc. . . .

### BACKGROUND OF INVENTION

The storage and retrieval of information has evolved from storing and retrieving information in textbooks and libraries, to storing and retrieving information from online networks such as the Internet. More particularly the Internet has led to a significant increase in the availability of information to the general public.

With the assistance of Internet Search Engines computer users can connect into computer systems located anywhere on the planet, find WebPages, find phone numbers, search through the world's best libraries, read online news reports, search for blog WebPages content and shop for almost anything.

Although using Internet search engines like Yahoo, MSN and Google to locate information over the Internet is effective, it is often slow and tedious. For example, for any given search query, there can be millions of Web pages that include a particular word or phrase, and some pages are more relevant, popular, or authoritative than others. As a result, search engine users can become overwhelmed by the enormous amount of unstructured and heterogeneous information. The usefulness of a search engine depends on the relevance of the results it gives back. Therefore, Internet searchers will often either gives up before finding the information they seek or lose track of the information.

Unfortunately there are many other common problems with Internet Search Engine queries that can present themselves to a searcher before the searcher finds the sought-for information. This is because the dynamic environment of the Internet web-document/titles (text link description) is constantly changing with additions, updates, and an ever expanding list of dead links.

Another problem is that the Internet search engines are extremely vulnerable to hackers. It is common for web page Hijacker to send Searchers to a completely different web site of which you have no control. Webpage hijacking and manipulation is so common that the jargon, “302 Google Jacking” has become popular.

Furthermore, another contributor to the search engine query results problems is the Internet Search Engines themselves by design Search Engines create many of the problems their users (searcher) are encountering with their search results being unrelated and filled with information redundancy.

Often Search Engines use one of two to ways optimizes search their results, and both methods have their advantages and disadvantages.
1. The first method is to optimize the Internet search engine for “synonymy”. If a search engine is optimized for “synonymy” then the users' results have low similarity, which means most of the search results will be related to the search topic meaning.
2. The second method is to optimize search engines on the opposite end of the spectrum, for “polysemy”. If search engines are optimized for “polysemy” then many of the search query results are going to be relatively high in similarity, which limits the users (searchers) findings because they are filled with redundant information.

In addition to the other problems with Internet search engines, the companies that provided and maintain the search engines also contributors to the search engine query results problems, with things like their keyword-positioning advertising programs.

With Search engine companies selling to the highest bidder top ranking position on the search engine's listings for key words, users query results are often becoming even less relative to their search query. This becomes is even more time consuming and annoying to people searching the Internet. Therefore, there is a need to improve in the way information is identified and the way in which users can access the desired information more easily.

The problems users are experiencing with search engine results being contradictory and redundant information is going to continue and most likely get even worst. Unfortunately, currently only a few primitive techniques have evolved that enable a user to simultaneously view searches engine query result images. These primitive techniques operate on a totally different principle and architectural design than the disclosed invention, and they all have very limited capabilities which falling far short in features and capabilities that meets the needs of information providers and information users (searchers).

However, the present invention addresses the foregoing problems with a new advanced information retrieval system which greatly reducing the problems search engine users are currently experiencing.

In addition to greatly reducing the problems search engine users are experiencing. The present invention also offers a very user-friendly method of previewing the images of WebPages, relevant to the search engine text query results. Which is desperately needed at this time considering the benefits the Internet has to offer?

### SUMMARY OF THE INVENTION

The following presents a simplified summary of the invention in order to provide a basic understanding of some aspects of the invention. This summary is not an extensive overview of the invention. It is not intended to identify key/critical elements of the invention or to describe the scope of the invention. Its sole purpose is to present some concepts of the invention in a simplified form as a prelude to the more detailed description that is presented later.

This invention relates to information search and retrieval systems and more specifically to search and retrieval systems, which utilize in whole or in part image webpage previewing techniques.

Other Internet search engines query results are indexed and presented to users in an very abstract information format using “document title” (text description links), which identifies web site content, and can be understandable to human users.

The present invention is a search engine system that addresses the problem of text query results, by the text data query results received from search engines. Then the invention associates each returned query document title description with one or more graphic images, which reveals the appearance of the web site, or some other characteristics associated with the WebPages.

While using the invention, Internet search engine users can preview images of WebPages, which are related to the returned search engine query results.

To preview a search engine's results documents titles (text link description) related WebPage, the user (searcher) simply positions their mouse cursor over the various results documents, returned from their Internet search engine query. This call to action displays the related webpage's screen shot image automatically on to the monitor screen for the user to review. This special feature allows the users (searchers) to make a quick visual determination as to which search engine query document links are best related to what the user (searcher) is searching for.

When compared to using the other conventional Internet search engines systems, such as Google, Yahoo, MSN, and AOL, initial test results show Users regardless of what internet service they are currently using, will see a significant increase in their Internet searching speeds.

There are several contributing factors for the significant increase in the users Internet searching speed. Most notably are the reduced bandwidth requirements and the utilization of a much more efficient system for making decisions as to the relativity of documents titles returned from their search engines queries results.

### DESCRIPTION OF THE DRAWING AND IMAGES

For demonstration purposed the Myseeks Internet Search Engine has been customizing with the disclosed invention and produced the attached screenshot images proving the invention is fully functional. There are also screenshot images provided of competitors search engines, showing they do not encompass this type of new and advanced image previewing technology.

Features and Benefits of the invention will now be described with reference to the drawings and screenshot images of certain preferred embodiments, which are intended to illustrate how it greatly differs from conventional search engines and not to limit the invention, and in which:

Drawing—Diagram of the Various Custom Components:

Diagram #M1. This is a detailed functionality diagram of the various custom components of the invention, which are described completely in the “DETAILED DESCRIPTION” section of the Patent Application.

Drawings—Graphics Related to the Search Engine Image Previewing Technologies:

Myseeks #1. With the Keyword “movies” entered into the Myseeks search box and ready for a search query to be performed.

Myseeks #2. This image is a screenshot of the returned Myseeks “movies” Query search results. It confirms that the related WebPages images are not automatically displayed for viewing and the search results return documents are only displayed at first.

Myseeks #3. This image is a screenshot of the turned Myseeks “movies” Query search results and it confirms the invisible image “QuickView” feature of this invention. In this screenshot the mouse courser has been positioned over the first query result document and to the right the related WebPages image is displayed to make a quick visual determination if the Web Site is of interest to them. From this point the user simply needs to position their mouse cursor over a query result to view the WebPages's image or click on the current link to access that website.

Myseeks #4 through #12. These screenshot images illustrate how when the user repositions their mouse cursor over other search query results, and different WebPages images related to those search results will appears.

Drawings: Adjustable Preview Image Size:

Adjustments Images #1 & #2. These images are screenshots of the query results review page, which show the preview image size can be adjusted and repositioned if so desired.

Drawings—Graphic Competition Comparison:

Competition Image #1. This image provides proof the Google Search engine system does not include an image-previewing feature, which the disclosed invention technologies offer. The image (Competition Image-1) is a screen shot of a Google Search results page after performing a query for the keyword “movies”.

This screenshot images demonstrates that when a Google Search Engine user passes their mouse courser over the search query return results, there are no images of a related WebPages displayed.

Competition Image #2. This image provides proof the Microsoft's MSN Search Engine system does not include an image-previewing feature, which the disclosed invention technologies offer. The image (Competition Image #2) is a screen shot of a Microsoft's MSN Search results page after performing a query for the keyword “movies”. This screenshot images demonstrates that when a Microsoft's MSN Search Engine user passes their mouse courser over the search query return results, there are no images of related WebPages displayed.

Competition Image #3. This image provides proof the Yahoo Search Engine system does not include an image-previewing feature, which the disclosed invention technologies offer. The image (Competition Image #3) is a screen shot of a Yahoo Search results page after performing a query for the keyword “movies”. This screenshot image demonstrates that when a Yahoo Search Engine user passes their mouse cursor over the search query return results, there are no images of related WebPages displayed.

Competition Image #4. This image provides proof the Ask Search Engine system does not include an image-previewing feature, which the disclosed invention technologies offer. The image (Competition Image #4) is a screen shot of an Ask Search results page after performing a query for the keyword “movies”. This screenshot image demonstrates that when an Ask Search Engine user passes their mouse courser over the search query return results, there are no images of related WebPages displayed.

Competition Image Alexa #5-9. These images provide evidence that the Alexa Search Engine system only includes a limited pre-load image-previewing feature, which is very different and is much more inferior to the disclosed invention technologies.

These images (Competition Image Alexa #5-9) are a series of screen shots of the Alexa Search results pages after performing a query for the keyword “movies”. The screenshot images show that the Alexa Search Engine merely pre-loads three thumbnail images of related WebPages and does not include a sophisticated invisible mouse-over images viewing system, which is incorporated into the disclosed inventions.

### DETAILED DESCRIPTION OF THE INVENTION

To the accomplishment of the foregoing and related ends, certain illustrative aspects of the invention are described herein in connection with the following description and the annexed drawings. These aspects are indicative, however, they're only but a few of the various ways in which the principles of the invention may be employed and the present invention is intended to include all such aspects and their equivalents. Other advantages and novel features of the invention may become apparent from the following detailed description of the invention when considered in conjunction with the drawings.

The present invention provides various features for assisting users in conducting online searches. The features may be embodied alone or in combination within search engines, Internet searches engines, or other types of search systems.

This disclosed invention is designed to provide an extremely fast way for people to search the Internet. Using this system users are able to quickly identify which of their search engine query results is relevant to what they are searching for, without having to go through the time consuming process of reading each search result “documents title” (text links) or downloading the actual websites.

To use the WebPages image previewing feature, the searcher first accesses a search engine (e.g., Yahoo, Google, Myseeks, Microsoft's MSN, WebCrawler, etc.). The searcher may access the selected search engine in many different ways such as; entering the website address of the particular search engine, the internet searcher may automatically be connected to the search engine upon start-up, through web browsers, toolbars, desktop tools, search boxes, etc. Search engines typically include a character entry window within which the searcher can enter search terms such as keywords and phrases.

After the entry of a search keyword or phrases (terms), the searcher selects a “search” icon. In response, the search engine searches for data sources (i.e., websites) which may have information related to the search term(s). Upon locating any websites that may have information related to the search term(s), the search engine compiles a list of search results.

Then through a combination Query Capture Analysis component and Image Indexing component, which make use of the query data results, obtained from Internet search engines. With this aspect users (Searchers) are provided a method to previewing an unlimited number of WebPages images, which are specifically related to their documents titles (text links) returned from the search engine query.

When the Query Capture Analysis component and Image Indexing component are activated the “User” (person searching the Internet) has an advanced Internet Searching feature. The user can now positions their mouse cursor over the various returned results from their internet search engine query and the related WebPages screen shots will automatically displayed on a monitor screen.

With this WebPages image previewing system users (searchers) are able to make quick visual determinations as to which search engine query links are best related to what the seek.

If a particular WebPages image appears to be something the user (search) would be interested in, the user can then either click on the corresponding link or image and connect to the actual website. Or if the WebPages' image is not something that interests the user, the user can reposition the cursor over another text link and continue previewing other WebPages' images.

By virtue of the foregoing, the invention has many aspects, which contribute to increase the speed in which Users can search the Internet more efficiently. Listed below are the primary reasons for the increases in Internet search speed that users can expect to experience:
A. The invention's Image Previewing feature dramatically reduces and can eliminate the users' (Internet searchers) time wasted reading the various documents (text links) query results. The Users (Internet Searchers) can quickly retrieve and preview images of desired WebPages without being required to go through the lengthy process of first downloading each WebPage, to find out if it relates to what they are searching for.
B. Another contributing factor to the increase in web search is the Users (Internet Searchers) can decide not to read the search engine results document titles text descriptions before knowing which websites are going to possibly contain the information they seek. Initial test results show that 100% of people tested found this “webpage image previewing feature” to be more efficient and enjoyable to use, than the traditional search engines systems like Google's, Yahoo's and Microsoft's MSN.
C. The embodied image components reduce the ISP's, website servers, and the Users' bandwidth requirements, which is another contributing factor for the increase in Internet searching speed and performance. Users (People searching the Internet) can expect to experience a significant increase in their Internet searching speed while using this invention.

This indexing and image delivery system can also be used to index different types of database accessed locally, or over a network. Such as web documents, sound files, videos, pictures, images, text documents, products, medical records, people searches, phone numbers, maps, etc.

### DETAILED DESCRIPTION TECHNICAL

Breakdown

This disclosed invention offers a unique and very effective way to compensate for the inherent problem experienced with computerized devices of having an insufficient amount of view screen/page area, when it comes to displaying multiple images of WebPages in combination with search engine query Results Page. More specifically, the invention encompasses a very unique mouse-over/mouse-out image previewing system for helping users navigate through search engine return query results, such as those obtained doing a Google or Yahoo Internet search.

Image Invisibility Component

With the use of an “Image Invisibility Component” (Section 11), the users will at first see their search engine query results displayed (Section 10) without the corresponding webpage images (Section 13). The Image Invisibility Component (Section 11) programs the WebPages Preview Images (Section 13) to first load as being invisible to the user on their display screen until the user (searcher) take action to the see images, which relates to their search query results.

Search Engine Component

Through the use of a database Search Engine that has been customized with the present invention, the user (searcher) types in keywords or phrases related to information they seek. The search engine then (Section 2) queries one or more databases (Meta-searches) in an attempt to locate documents related to the user's entered keywords or phrases (Section 1). Databases being searched for the related information can be localized and/or remote databases such as one that is connected via the Internet (World Wide Web). The returned search query results are then indexed using a unique algorithm and then filed into the “Search Query History Database” (Section 3) located on a remote server. There are many different types of search engines that can be customized with the present invention such as, but not limited to: Internet search engines (Section 3), desktop searches, web browsers, webpage search boxes (Section 1), image search engines, news search engines, shopping search engines, toolbars, etc. . . .

Repeat Search Query Checker

For faster retrieval times and to reduce bandwidth usage, an optional repeat search engine queries application is included. The Repeat Search Query Checker can retrieved from a remote database and/or databases called the Search Query History Database (section 3), which stores previous search engine query results. The Repeat Search Query Checker (section 4) cross-references the user's keyword(s) or phrase(s) requests with a remote Search Query History Database (section 3) of previous keyword(s) and/or phrase(s) searched. If the Repeat Search Query Checker (section 4) determines a keyword or phase has not been searched earlier, then the Repeat Search Query Checker (section 4) instructs the search engine (section 2) to perform a new search query.

If a keyword or phrase has been searched earlier, within a predetermined time frame; for example 24 hours, then the search engine will bypass performing a new search query (section 2). The finished search query results are forwarded to the “Search Results Component” (section 5) for processing.

Search Results Component

The Search Results Component (section 5) receives the search query results information from the Search Query History Component (section 3). The Search Results Component (section 5) then analyzes the unique search query results information to determine which requests for WebPage preview images are to be sent to the “Image Retrieval Component” (section 6). The Search Results Component (section 5) also forwards the search query results information (sample section 13) which many things such as; the document description, title, and page URL to the Final Stage Component (section 9).

Imaging Retrieval Component

The Image Retrieval Component (section 6) receives the search query results and related WebPages preview image information from the Search Results Component (section 5). The Image Retrieval Component (section 6) then retrieves the assigned WebPages Preview images from the Image Database Component (section 7), and forwards the images to the Final Stage Component (section 9).

Image Database Component

The Image Database (section 7) consists of digital images of web pages stored on a remote server, which are created and maintained by the Image Database Creation Component. The Image Database (section 7) receives requests from the Image Retrieval Component (section 6) for Images of Web Pages, which relates to the user's search engine query results. Requested images that are available in the Image Database are returned to the “Image Retrieval Component” (section 6) to be processed. And from there the Image Retrieval Component (section 6) forwards the images to the Final Stage Component (section 9). If a requested Webpage Preview images is not available in the Image Database (section 7). Then the Image Database (section 7) provides to the Image Retrieval Component (section 6) an error WebPages image, which is used as a substitute to an image of the actual WebPage. For example the error image can simply read “Image Not Available”, for this WebPage.

Final Results Stage Component

The Final Results Stage Component (section 9) matches the search query results received from the Search Results Component (section 5) with the related WebPages preview images received from the Image Retrieval Component (section 5). After the Final Stage Component (section 9) has completed the file match-up and re-index process, then the modified search query results are forwarded to the Search Results Browser Screen (section 10) for the user to review. The search result viewing screen/page (Section 10) displays the title, description, ranking, page URL and other common characteristics, which can be replaced or modified with a system update. The search results view screen (Section 10) is a program that displays the first 10-search results, however the number of results displayed and the order in which they are displayed can be changed to accommodate potential future needs. Search results pages (Section 10) are also equipped with a search bar and contextual feed section for sponsored ads. At the bottom Search Results viewing pages (Section 13) is an option for the user to review additional search results (a page number of other pages or a next button), if the user (searcher) desires to search more pages.

1. With the use of an “Image Invisibility Component” (Section 11) the users will at first see their search engine query results displayed (Section 10) without the corresponding webpage images (Section 13). The Image Invisibility Component (Section 11) programs the WebPages Preview Images (Section 13) to first load as being invisible to the user on their display screen until the user (searcher) take action to the see images which relates to their search query results.

2. Through the use of a database Search Engine that has been customized with the present invention, the user (searcher) types in keywords or phrases related to information they seek. The search engine then (Section 2) queries one or more databases (Meta-searches) in an attempt to locate documents related to the user's entered keywords or phrases (Section 1). Databases being searched for the related information can be localized and/or remote databases such as one that is connected via the Internet (World Wide Web). The returned search query results are then indexed using a unique algorithm and then filed into the “Search Query History Database” (Section 3) located on a remote server. There are many different types of search engines that can be customized with the present invention such as, but not limited to: Internet search engines (Section 3), desktop searches, web browsers, webpage search boxes (Section 1), image search engines, news search engines, shopping search engines, toolbars, etc. . . .

3. For faster retrieval times and to reduce bandwidth usage, an optional repeat search engine queries application is included. The Repeat Search Query Checker can retrieved from a remote database and/or databases called the Search Query History Database (section 3), which stores previous search engine query results. The Repeat Search Query Checker (section 4) cross-references the user's keyword(s) or phrase(s) requests with a remote Search Query History Database (section 3) of previous keyword(s) and/or phrase(s) searched. If the Repeat Search Query Checker (section 4) determines a keyword or phase has not been searched earlier, then the Repeat Search Query Checker (section 4) instructs the search engine (section 2) to perform a new search query.

4. If a keyword or phrase has been searched earlier, within a predetermined time frame; for example 24 hours, then the search engine will bypass performing a new search query (section 2). The finished search query results are forwarded to the “Search Results Component” (section 5) for processing.

5. The Search Results Component (section 5) receives the search query results information from the Search Query History Component (section 3). The Search Results Component (section 5) then analyzes the unique search query results information to determine which requests for WebPage preview images are to be sent to the “Image Retrieval Component” (section 6). The Search Results Component (section 5) also forwards the search query results information (sample section 13) which many things such as; the document description, title, and page URL to the Final Stage Component (section 9).

6. The Image Retrieval Component (section 6) receives the search query results and related WebPages preview image information from the Search Results Component (section 5). The Image Retrieval Component (section 6) then retrieves the assigned WebPages Preview images from the Image Database Component (section 7), and forwards the images to the Final Stage Component (section 9).

7. The Image Database (section 7) consists of digital images of web pages stored on a remote server, which are created and maintained by the Image Database Creation Component.

8. The Image Database (section 7) receives requests from the Image Retrieval Component (section 6) for Images of Web Pages, which relates to the user's search engine query results.

9. Requested images that are available in the Image Database are returned to the “Image Retrieval Component” (section 6) to be processed. And from there the Image Retrieval Component (section 6) forwards the images to the Final Stage Component (section 9).

10. If a requested Webpage Preview images is not available in the Image Database (section 7). Then the Image Database (section 7) provides to the Image Retrieval Component (section 6) an error WebPages image, which is used as a substitute to an image of the actual WebPage. For example the error image can simply read “Image Not Available”, for this WebPage.

11. The Final Stage Component (section 9) matches the search query results received from the Search Results Component (section 5) with the related WebPages preview images received from the Image Retrieval Component (section 5).

12. After the Final Stage Component (section 9) has completed the file match-up and re-index process, then the modified search query results are forwarded to the Search Results Browser Screen (section 10) for the user to review.

13. The search result viewing screen/page (Section 10) displays the title, description, ranking, page URL and other common characteristics, which can be replaced or modified with a system update.

14. The search results view screen (Section 10) is a program that displays the first 10-search results, however the number of results displayed and the order in which they are displayed can be changed to accommodate potential future needs. Search results pages (Section 10) are also equipped with a search bar and contextual feed section for sponsored ads.

15. At the bottom Search Results viewing pages (Section 13) is an option for the user to review additional search results (a page number of other pages or a next button), if the user (searcher) desires to search more pages.
